(19) United States
(12) Patent Application Publication
(10) Pub. No.: US 2025/0110771 A1
(43) Pub. Date: Apr. 3, 2025

(54) USING DOCKER COMPOSE IN A DOCKER-BASED EMBEDDED IoT EDGE DEVICE

(71) Applicant: LEXMARK INTERNATIONAL, INC., LEXINGTON, KY (US)

(72) Inventors: PETER STEWART DAVIDSON, JR., LEXINGTON, KY (US); JOSHUA AARON DELONG, LEXINGTON, KY (US)

(21) Appl. No.: 18/905,352

(22) Filed: Oct. 3, 2024

Related U.S. Application Data
(60) Provisional application No. 63/542,273, filed on Oct. 3, 2023.

(51) Int. Cl. G06F 9/455

(52) U.S. Cl. CPC G06F 9/45558; G06F 2009/45562; G06F 2009/4557; G06F 2009/45575

(57) ABSTRACT

A method is disclosed to seamlessly migrating multi-container Docker Compose applications to a single container IoT Edge System greatly expands the number of applications and solutions available. The ability to run multi-container Docker Compose applications on single container per application IoT Edge Devices with no significant modifications to the application and without impacting the security of the IoT Edge Device and System is accomplished by having a special container, called Composer, that can run Docker Compose commands to start, stop, and manage compose applications. In the IoT Edge System, a special Composer Controller container is created, that uploads the compose application to Composer. Once uploaded, the Composer Controller container instructs Composer to run the compose application.

### CROSS REFERENCES TO RELATED APPLICATIONS

This application claims priority to U.S. Provisional Pat. App. Ser. No. 63/542,273 titled “Using Docker Compose in a Docker-based Embedded IoT Edge Device,” filed on Oct. 3, 2023, the entirety of which is incorporated here by reference.

### BACKGROUND

### 1. Field of the Invention

This invention relates generally to using an IoT Edge System to communicate with and manage a plurality of IoT Edge Devices.

### 2. Description of the Related Art

The relevant art consists of components of an IoT Edge device used to deliver secure applications.

### SUMMARY OF THE INVENTION

Seamlessly migrating multi-container Docker Compose applications to a single container IoT Edge System greatly expands the number of applications and solutions available. The ability to run multi-container Docker Compose applications on single container per application IoT Edge Devices with no significant modifications to the application and without impacting the security of the IoT Edge Device and System is accomplished by having a special container, called Composer, that can run Docker Compose commands to start, stop, and manage compose applications. In the IoT Edge System, a special Composer Controller container is created, that uploads the compose application to Composer. Once uploaded, the Composer Controller container instructs Composer to run the compose application. Since only Composer has special privileges to execute Docker Compose commands and the Composer Controller container does not, the system is protected from security threats.

### BRIEF DESCRIPTION OF THE DRAWINGS

Having thus described the invention in general terms, reference will now be made to the accompanying drawings, which are not necessarily drawn to scale, and wherein:

FIG. 1 shows an IoT Edge System running behind a firewall that communicates with and manages a plurality of IoT Edge Devices.

FIG. 2 shows the internal components of the IoT Edge Device and various external devices.

FIG. 3 shows the method the Composer container uses for normal running.

FIG. 4 shows the method the Composer container uses to shut down.

FIG. 5 shows the method the IoT Edge system uses to start a new Composer Application.

FIG. 6 shows the method the IoT Edge system uses to remove the Composer container.

FIG. 7 shows the method the IoT Edge system uses to query the Composer Application.

### DETAILED DESCRIPTION

It is to be understood that the present disclosure is not limited in its application to the details of construction and the arrangement of components set forth in the following description or illustrated in the drawings. The present disclosure is capable of other embodiments and of being practiced or of being carried out in various ways. Also, it is to be understood that the phraseology and terminology used herein is for the purpose of description and should not be regarded as limiting. As used herein, the terms “having,” “containing,” “including,” “comprising,” and the like are open ended terms that indicate the presence of stated elements or features, but do not preclude additional elements or features. The articles “a,” “an,” and “the” are intended to include the plural as well as the singular, unless the context clearly indicates otherwise. The use of “including,” “comprising,” or “having” and variations thereof herein is meant to encompass the items listed thereafter and equivalents thereof as well as additional items. Terms such as “about” and the like are used to describe various characteristics of an object, and such terms have their ordinary and customary meaning to persons of ordinary skill in the pertinent art.

The present invention now will be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like numerals refer to like elements throughout the views.

A Docker-based Embedded IoT Edge Device is a specialized computing device designed to perform Internet of Things (“IoT”)—related tasks at or near the source of data generation within an IoT network. This would be, e.g., a computer running behind a firewall and in a physical location close to sensors to observe various activities. This device may incorporate Docker containerization technology, or equivalent, for efficient application deployment and management. The devices are connected to a communication method that allows communication to a central location that manages a plurality of IoT Edge Devices. These devices are herein known as “IoT Edge Devices.”

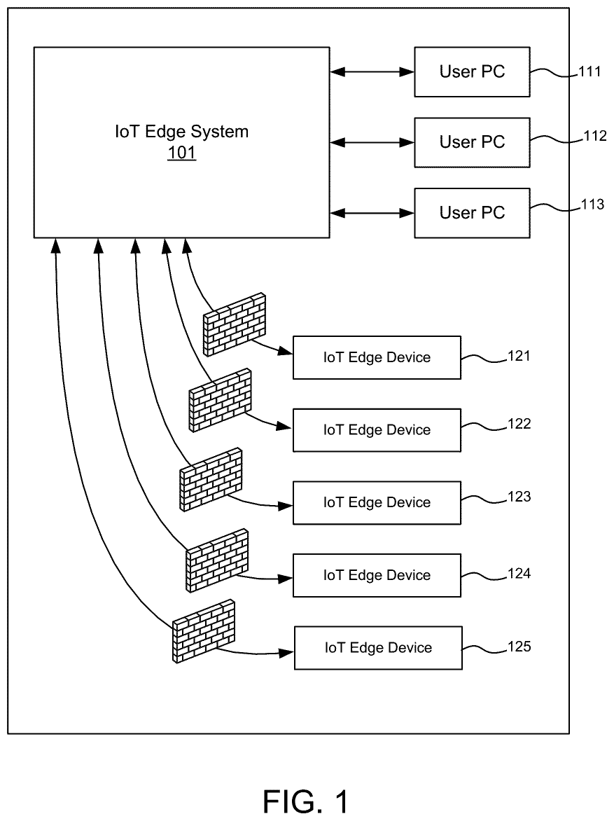

Referring initially to FIG. 1, which shows an IoT Edge System 101 accessible by multiple User PCs 111, 112, 113. The IoT Edge System 101 is running behind a firewall that communicates with and manages a plurality of IoT Edge Devices 121, 122, 123, 124, 125.

The management of IoT Edge Devices is performed by a cloud or device-based IoT Edge System graphical user interface (“GUI”), which controls what applications are downloaded and run on the device. This system is herein known as the “IoT Edge System.”

Basic container orchestration is performed by the IoT Edge System. In this ecosystem, an application is housed in one container. Multiple containers may run on one device and work together, but each container must be configured independently. Generally, in a Docker-based Embedded IoT Edge System, one application equals one container.

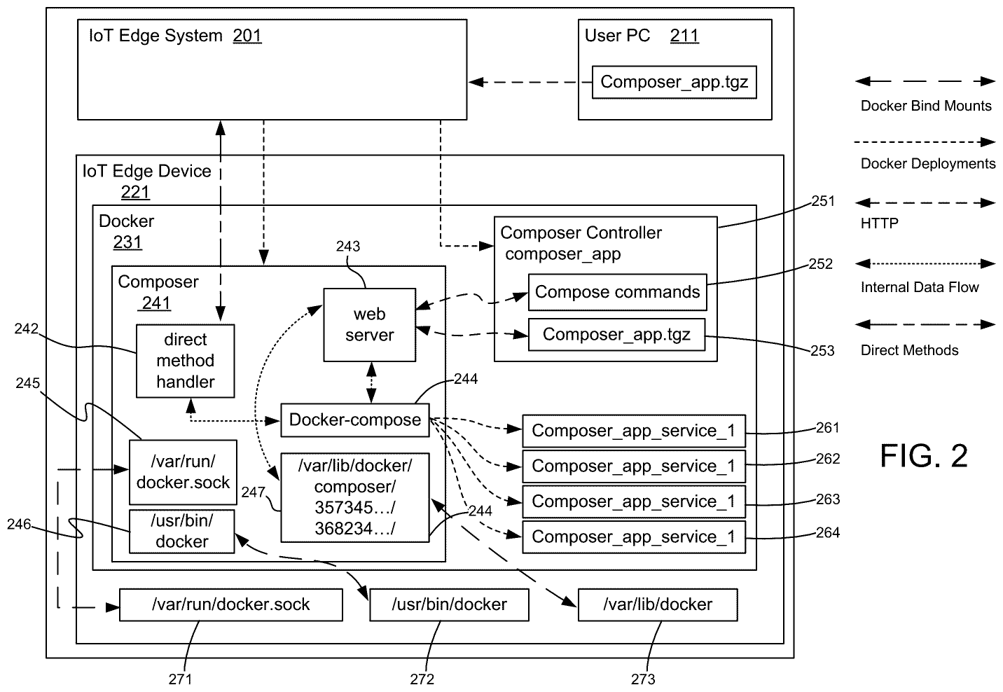

FIG. 2 shows an IoT Edge Device 221 with Docker 231 contained therein and Composer 241 and Composer Controller 251 shown. Composer may directly interface with an IoT edge system 201, and is comprised of a direct method handler 242 that may also directly interface with the IoT edge system 201, which also interfaces with the User PC 211. The direct method handler 242 interconnects with Docker-compose 244, which interconnects with a web server 243. Other elements include /var/run/docker.sock 245 and the /usr/bin/docker 246, both of which interconnect with their external counterparts 271, 272. The IoT edge system 201 and web server 243 interconnect with the composer controller (composer_app) 251 and the compose commands 252 and composer_app.tgz 253. The Docker-compose 244 interconnects with the Composer_app_service_1 261, 262, 263, 264. Finally the /var/lib/docker/composer 244 interconnects with the web server 243 and its external counterpart /var/lib/docker 273.
a User PC, an IoT Edge System, and an IoT Edge Device. Further it shows the internals of the IoT Edge Device: Docker system, Composer container, Composer Controller container, the containers created by Docker Compose, various system files, and their interconnections.

Docker Compose is a basic orchestration tool that allows you to define and manage multi-container Docker applications. It simplifies the process of creating, running, and managing complex applications that consist of multiple interconnected services or components. It simplifies the management of multi-container applications by providing a way to define, configure, and run multiple services in a coordinated manner. It improves development efficiency, enhances reproducibility, and streamlines the deployment process. Generally, in Docker Compose, one application equals many containers.

While the single container system works well, there are many existing Docker Compose applications that are comprised of multiple “microservices,” each in its own container. Migrating these applications to the IoT Edge System is problematic. Each of the Docker Compose containers must be refactored and merged into one container. This requires significant development effort and negates all testing that was performed previously.

Seamlessly migrating multi-container Docker Compose applications to a single container IoT Edge System greatly expands the number of applications and solutions available. The ability to run multi-container Docker Compose applications on single container per application IoT Edge Devices with no significant modifications to the application and without impacting the security of the IoT Edge Device and System is accomplished by having a special container, called Composer, that can run Docker Compose commands to start, stop, and manage compose applications. In the IoT Edge System, a special Composer Controller container is created, that uploads the compose application to Composer. Once uploaded, the Composer Controller container instructs Composer to run the compose application. Since only Composer has special privileges to execute Docker Compose commands and the Composer Controller container does not, the system is protected from security threats.

### Detailed Description

The basic idea is to run Docker Compose from inside a docker container that has been given special privileges. This container must have access to the docker socket, /var/run/docker. It must have access to the docker executable, /usr/bin/docker. Finally, it must have access to a workspace on the host, /var/lib/docker. These three items require special privileges that are not allowed for normal container containers. Further, it must contain the executables for docker compose.

This container, called Composer, allows the IoT Edge System through direct methods, and other containers on the device through web endpoints, to tell Composer to upload Docker Compose applications to Composer's special work area on /var/lib/docker and then what docker compose commands to execute on the application.

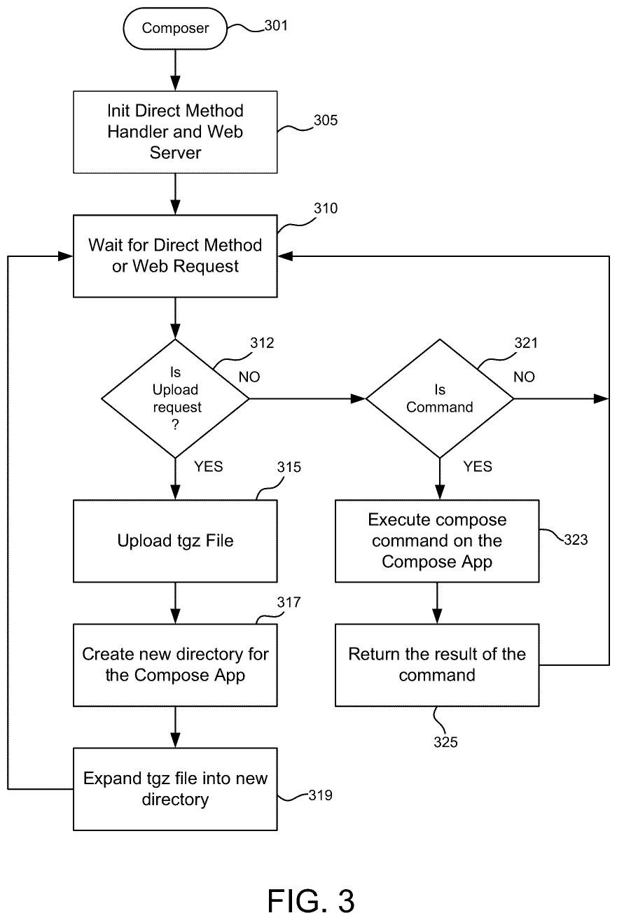

FIG. 3 shows the method the Composer 301 container users for normal running. Composer 301 initiates the Direct Method Handler and Web Server 305, then waits for the Direct Method or Web Request 310. The method queries if an Upload request is made 312, and if yes, then Uploads the tgz file 315. A new directory for the Compose App is created 317, and the tgz file is expanded into the new directory 319 and returns to the waiting point 310. If an Upload request is not made, then the methods queries for a different command 321, if there is no other command, then the method returns to the waiting point 310. If a command is issued, then the compose command is executed on the Compose App 323, the result of the command is returned 325, and the method returns to the waiting point 310.

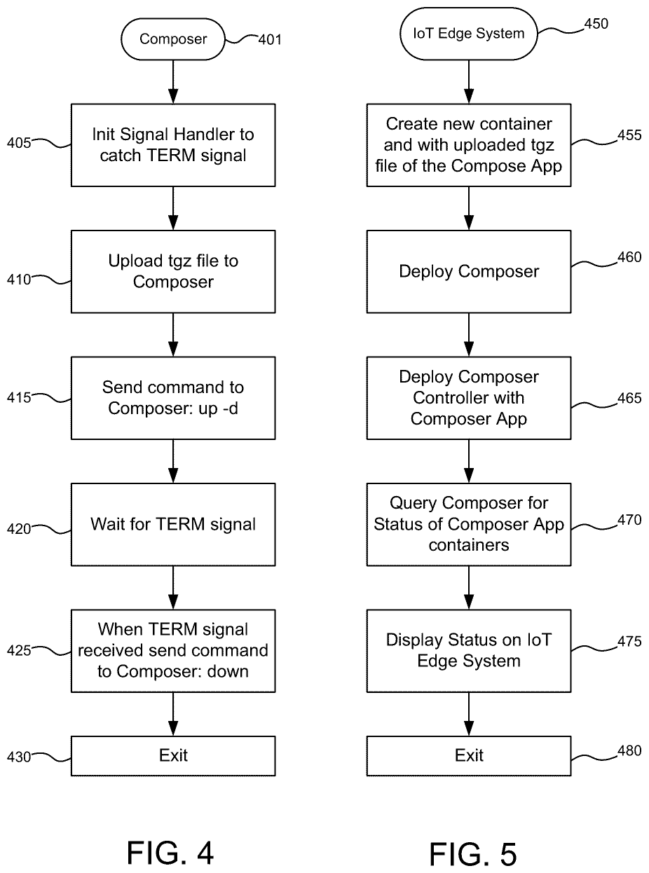

FIG. 4 shows the method the Composer container uses to shut down. Composer 401 initiates a signal handler to catch TERM signal 405, uploads a tgz file to Composer 410, sends the command “up-d” to Composer 415, waits for the TERM signal 420, upon receipt of TERM signal, sends the “down” command to Comper 425, and Exits 430.

FIG. 5 shows the method the IoT Edge system uses to start a new Composer Application. The IoT Edge System 450 creates a new container with the uploaded tgz file of the Compose App 455, deploys Composer 460, deploys Composer Controller with Composer App 465, queries Composer for the status of Composer App containers 470, displays the status on the IoT Edge System 475, and Exits 480.

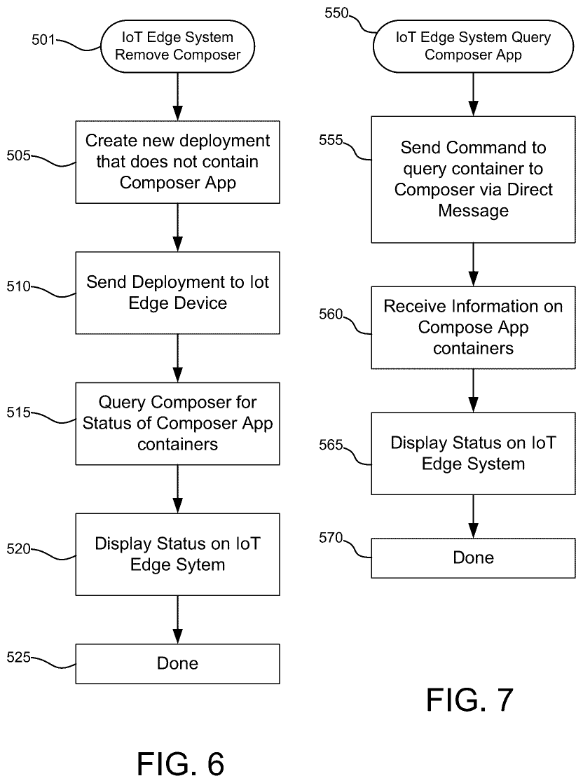

FIG. 6 shows the method the IoT Edge system uses to remove the Composer container. To remove the Composer container, the IoT Edge System 501 creates a new deployment that does not contain Composer App 505, sends deployment to the IoT Edge Device 510, queries Composer for the status of the Composer App containers 515, displays the status on the IoT Edge System 520, and finishes 525.

FIG. 7 shows the method the IoT Edge system uses to query the Composer Application. The IoT Edge System queries the Composer App 550 by sending a command to query the container to Composer via Direct Message 555, receives information on Compose App containers 560, displays the status on IoT Edge System 565, and finishes 570.

A Docker Compose application is a directory with at least one file in it called compose.yaml. This file is used to define and configure multiple Docker containers that make up a multi-container application. It is a declarative configuration file that allows one to specify various settings for each container, such as the image to use, environment variables, ports, networks, and more. Docker Compose uses this file to manage the orchestration of containers, making it easier to develop, test, and deploy complex applications that consist of interconnected services.

Docker Compose has a broad set of capabilities, some of which may be used to compromise the host system. Therefore, Composer protects against this in the following ways:
1. Allowing only a subset of Docker Compose commands which are safe. Those commands are:
   a. up, up -d
   b. down
   c. logs, logs -f
   d. ps
   e. stop
   f. start
   g. rm, rm -f, rm -v, rm -s -f -v
2. Making a careful and critical examination of the compose.yaml file for problematic directives. The directives include:
   a. Access to the directory ‘/’ or ‘˜/’
   b. Access to any directory that contains ‘ . . . ’
   c. Access to host ports that are used by the host: 22, 80, 443
3. Making a careful and critical examination of the compose.yaml file to allow only specific service keys. The service keys include:
   a. command
   b. container_name
   c. depends_on
   d. device_cgroup_rules
   e. labels
   f. environment
   g. expose
   h. init
   i. networks
   j. ports
   k. restart
   l. stop_gracePperiod
   m. stop_signal
   n. volumes
      The steps to create and run an existing Docker Compose application are as follows:
1) Access the Docker Compose application directory, e.g., compose_app. Which must contain a compose.yaml file;
2) Compress the directory into one file, compose_app.tgz;
3) Creating on the IoT Edge System a new Composer Controller container called compose_app that will contain the compose_app;
4) Uploading the compose_app.tgz to the new container, which creates a container that contains the compose_app.tgz file and executables that can communicate to the Composer container on the IoT Edge Device (the name of this container is an 18-digit number);
6) Deploying the container to an IoT Edge Device:
7) Deploying Composer first, if needed, when deploying the Composer Controller container;
8) Uploading the compose_app.tgz file to Composer when the Composer Controller container starts;
9) Creating a new directory with the name of the new container created (18-digit number) and then expand the compose_app.tgz file into it;
10) Making a careful and critical examination of the compose.yaml file to verify there are no security threats;
11) The Composer Controller container then tells Composer to run “docker-compose up -d” to start the compose application;
12) Composer then executes the “docker-compose up-d” command in the newly created Directory;
13) The compose_app containers start running; and
14) The IoT Edge System queries Composer with direct methods to see what containers have been started by the docker-compose command, which are then displayed in the IoT Edge System as running containers under compose_app.

The steps to remove a Docker Compose application are as follows:
1) User removes the Composer Controller container compose_app from the IoT Edge System, which causes the compose_app container to get the term signal;
3) the compose_app container tells Composer to do the “docker-compose down” command;
4) Then all the containers of the compose_app shut down; and
5) The compose_app container terminates.

The IoT Edge System also may restart or query the status and logs of the separate running containers of the compose_app by sending direct methods to Composer, which then executes the necessary docker-compose commands to return the data.

The Composer Controller may be further improved. Instead of having the file composer_app.tgz file built into the Composer Controller, the Composer Controller may download the composer_app.tgz file and place it in a Docker Volume. The Composer Controller gets the URL for the composer_app.tgz file from the module twin. It also monitors changes in the module twin to see if the composer_app.tgz has changed and must be downloaded again.

This yields the following benefits: (1) Composer Controller does not have to be modified each time the app is changed. The only thing that changes is the URL of the composer_app.tgz in the device twin; and (2) A Docker Volume is used to store the composer_app.tgz file so that it does not have to be downloaded again after a reboot.

The foregoing description of several embodiments of the invention has been presented for purposes of illustration. It is not intended to be exhaustive or to limit the invention to the precise forms disclosed, and obviously many modifications and variations are possible in light of the above teaching. It is intended that the scope of the invention be defined by the claims appended hereto.

We claim:

1. A method to create and run an existing Docker Compose application comprising:
accessing a Docker Compose application directory, compose_app, that contains a compose.yaml file;
compressing the directory into one file, compose_app.tgz;
creating on an IoT Edge System a new Composer Controller container called compose_app that will contain the compose_app;
uploading the compose_app.tgz to the new container, which creates a container that contains the compose_app.tgz file and executables that can communicate to the Composer container on the IoT Edge Device;
deploying the container to an IoT Edge Device:
deploying Composer first when deploying the Composer Controller container;
uploading the compose_app.tgz file to Composer when the Composer Controller container starts;
creating a new directory with the name of the new container created;
expanding the compose_app.tgz file into the new directory;
examining of the compose.yaml file to verify there are no security threats;
starting the compose application by having the Composer Controller container tells Composer to run “docker-compose up -d”;
executing the “docker-compose up -d” command in the newly created directory;
running the compose_app containers; and
querying Composer to determine what containers have been started by the docker-compose command.

2. A method to remove a Docker Compose application comprising:
removing the Composer Controller container compose_app from the IoT Edge System, which causes the compose_app container to get a termination signal;
directing Composer to do “docker-compose down”;
shutting down all the containers of the compose_app; and
terminating the compose_app container.

3. A method to extend a one container per application IoT Edge System to allow multiple containers per application using Docker Compose on the IoT Edge Device.

4. The method of claim 3, but using Docker Compose inside a docker container with special privileges on the IoT Edge Device.

5. A method of extracting information about Docker Compose containers running on an IoT Edge Device to display on the IoT Edge System by communication with a container running Docker Compose.
